(19) United States
(12) Patent Application Publication
(10) Pub. No.: US 2010/0247817 A1
(43) Pub. Date: Sep. 30, 2010

(54) INKJET RECORDING MEDIUM AND METHOD FOR PRODUCING THE SAME AND RECORDING MEDIUM SUPPORT AND METHOD FOR PRODUCING THE SAME

(75) Inventors: Ryoichi NAKANO, Shizuoka-ken (JP); Daisuke KASHIWAGI, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/704,541

(22) Filed: Feb. 12, 2010

(30) Foreign Application Priority Data
Mar. 26, 2009 (JP) 2009-077517

(51) Int. Cl. B41M 5/50; B44C 1/17; B32B 3/00

(52) U.S. Cl. 428/32.34; 156/237; 428/141

(57) ABSTRACT

An inkjet recording medium is disclosed. The inkjet recording medium includes a paper support, a resin layer having a thickness of from 2 μm to 20 μm and an ink receiving layer containing a pigment and a water-soluble resin provided in this order on the paper support, wherein a center surface average roughness (SRa value) of a surface of the ink receiving layer provided on the paper support is 0.08 μm or less, provided that the SRa value is measured at a cutoff value of from 0.2 mm to 0.3 mm.

This application is based on and claims priority under 35 USC 119 from Japanese Patent Application No. 2009-077517 filed on Mar. 26, 2009, the disclosure of which is incorporated herein by reference in its entirety.

### BACKGROUND OF THE INVENTION

1. Field of the Invention

The present invention relates to an inkjet recording medium and a method for producing the same, and the present invention also relates to a recording medium support and a method for producing the same.

2. Description of the Related Art

In recent years, along with rapid development in information technology, a variety of information processing systems have been developed, and recording methods and recording devices suitable for the respective information processing systems have also been developed and put to practical use. Among these recording methods, an inkjet recording method has been widely used not only in offices but also in private homes, because the inkjet recording method has the advantages that the method allows recording on a variety of recording media, hardware (apparatus) is relatively inexpensive and compact, the method is excellent in terms of quietness, and the like.

Further, along with the recent trend in inkjet printers toward higher definition and the recent development of hardware (apparatus), various kinds of media for use in inkjet recording (hereinafter, also referred to as “inkjet recording media”) are being developed and, more recently, it has become possible to obtain photograph-like high-quality recorded materials.

Specifically, an inkjet recording medium is generally required to have properties such as (1) quick-drying properties (high ink absorption rate), (2) appropriate and uniform ink dot diameter (without ink bleeding), (3) excellent granularity, (4) high dot circularity, (5) high color density, (6) high saturation (without dullness), (7) excellent light fastness, gas resistance, and water resistance of a printed image portion, (8) a high degree of whiteness of a recording face, (9) excellent storability of a recording medium (absence of yellowing and image bleeding during long-term storage), (10) resistance to deformation and excellent dimensional stability (sufficiently low curling), and (11) excellent traveling properties within hardware.

Further, with regard to photographic glossy paper which is used for obtaining photograph-like high-quality recorded materials, properties such as glossiness, surface smoothness, texture similar to that of silver halide photographic printing paper, and the like are also required in addition to the properties above.

As inkjet recording media designed to increase glossiness, inkjet recording media having a gloss layer provided as an upper layer of an ink receiving layer by a cast coating method or a transfer method are known (see, for example, Japanese Patent Application Laid-Open (JP-A) No. 2001-219644, 2007-130786, or 2002-264474).

Moreover, a technique for forming an ink receiving layer by a transfer method is known (see, for example, JP-A No. 2003-154748 or 9-183265).

However, in these conventional inkjet recording media, improvements in image clarity and glossiness and a reduction in brittleness cannot be achieved at the same time in some cases.

### SUMMARY OF THE INVENTION

The present invention has been made in view of the above circumstances.

According to a first aspect of the present invention, the following inkjet recording medium is provided.

<1> An inkjet recording medium including a paper support, and a resin layer having a thickness of from 2 μm to 20 μm and an ink receiving layer containing a pigment and a water-soluble resin provided in this order on the paper support, wherein a center surface average roughness (SRa value) of a surface of the ink receiving layer provided on the paper support is 0.08 μm or less, provided that the SRa value is measured at a cutoff value of from 0.2 mm to 0.3 mm.

### DETAILED DESCRIPTION OF THE INVENTION

According to second to tenth aspects of the present invention, the following inkjet recording medium and a method for producing the same are provided.

<2> The inkjet recording medium according to <1>, wherein, the resin layer is formed by transferring the resin layer from a transfer material including the resin layer on a temporary support, onto the paper support.

<3> A method for producing an inkjet recording medium, the method including a resin layer formation process that forms a resin layer having a thickness of from 2 μm to 20 μm on a paper support by transferring the resin layer from a transfer material containing the resin layer on a temporary support and an ink receiving layer formation process that forms an ink receiving layer containing a pigment and a water-soluble resin on the resin layer formed on the paper support.

<4> The method for producing an inkjet recording medium according to <3>, wherein the transferring of the resin layer is carried out by heat pressure bonding.

<5> The method for producing an inkjet recording medium according to <3> or <4>, further including: prior to the formation process of the resin layer on the paper support, a transfer material producing process that produces the transfer material by applying a resin composition onto the temporary support and drying the resin composition to form the resin layer on the temporary support.

<6> The method for producing an inkjet recording medium according to any one of <3> to <5>, wherein the temporary support is a resin film.
<7> The method for producing an inkjet recording medium according to any one of <3> to <6>, wherein a center surface average roughness (SRa value) of a surface of the ink receiving layer provided on the paper support is 0.08 μm or less, provided that the SRa value is measured at a cutoff value of from 0.2 mm to 0.3 mm.

<8> A recording medium support having a resin layer having a thickness of from 2 μm to 20 μm on a paper support, in which a center surface average roughness (SRa value) of a surface of the resin layer provided on the paper support is 0.08 μm or less, provided that the SRa value is measured at a cutoff value of from 0.2 mm to 0.3 mm.

<9> The recording medium support according to <8>, wherein the resin layer is formed by transferring the resin layer from a transfer material including the resin layer on a temporary support onto the paper support.

<10> A method for producing a recording medium support, the method including a process that forms a resin layer having a thickness of from 2 μm to 20 μm on a paper support by transferring the resin layer from a transfer material including the resin layer on a temporary support.

The present invention can provide an inkjet recording medium having excellent image clarity and glossiness and reduced brittleness and a method for producing the same.

The present invention can also provide a recording medium support capable of producing a recording medium having excellent image clarity and glossiness and reduced brittleness and a method for producing the same.

First, a recording medium support and a method for producing the same of the present invention are described, and then an inkjet recording medium and a method for producing the same of the present invention are described.

Recording Medium Support

A recording medium support of the invention has a resin layer having a thickness of from 2 μm to 20 μm on a paper support, in which a center surface average roughness (SRa value) of a surface of the resin layer provided on the paper support measured at a cutoff value of from 0.2 mm to 0.3 mm is 0.08 μm or less, provided that the SRa value is measured at a cutoff value of from 0.2 mm to 0.3 mm.

According to the recording medium support of the invention, since a center surface average roughness (SRa value) of a resin layer is 0.08 μm or less, the flatness and smoothness of the surface of a layer when the layer is provided on the resin layer increases. Thus, the image clarity and the glossiness are improved by the recording medium produced using the recording medium support.

Moreover, according to the recording medium support of the invention, since the thickness of the resin layer is 2 μm or more, the surface of the resin layer is hardly influenced by irregularities of the paper support, and thus the flatness and smoothness on the surface of the resin layer increases. In accordance with the improvement in the flatness and smoothness of the surface of the resin layer, the flatness and smoothness of the surface of a layer when the layer is provided on the resin layer increases. Thus, the image clarity and glossiness increase in the recording medium produced using the recording medium support.

According to the recording medium support of the invention, since the thickness of the resin layer is 20 μm or less, the brittleness of the resin layer decreases. In accordance therewith, the brittleness of a layer when the layer is provided on the resin layer increases.

Thus, a recording medium having excellent image clarity and glossiness and reduced brittleness can be produced by the use of the recording medium support of the invention.

The resin layer of the recording medium support of the invention is thinner than that of a common polyolefin coat paper (referred to as “WP (water proof) paper”) in which a base paper is covered with polyolefin by melt extrusion. Thus, the productivity, recycling properties, and texture as paper are excellent.

In the invention, a center surface average roughness on the surface (SRa value) of a resin layer provided on the paper support (hereinafter also referred to as a “surface roughness SRa of a resin layer”) refers to a value obtained by measuring the surface of the resin layer provided on the paper support by NEW VIEW 5022 (trade name, manufactured by Zygo) under the conditions of a cutoff value of from 0.2 mm to 0.3 mm, a measurement length of 1 cm in the X direction and 1 cm in the Y direction, and a lens magnification of 2.5 times. The surface roughness SRa of each of the ink receiving layer, the paper support, and the temporary support described later refers to a value measured by the same method.

When the surface roughness SRa of the resin layer provided on the paper support exceeds 0.08 μm, the surface roughness of a layer when the layer is provided on the resin layer increases and furthermore the image clarity and the glossiness of the recording medium deteriorate.

From the viewpoint of further improving the image clarity and the glossiness of the recording medium produced using the recording medium support of the invention, the surface roughness SRa of the resin layer is preferably 0.06 μm or less and more preferably 0.05 μm or less.

Methods for obtaining the surface roughness SRa of the resin layer in the invention are not particularly limited. For example, a method for forming a resin layer by transfer described later is preferable, and in particular a method for producing a recording medium support of the invention described below is preferable.

When the thickness of the resin layer in the invention is less than 2 μm, the irregularities of the paper support are likely to be reflected on the surface of the resin layer. Thus, the image clarity and the glossiness deteriorate in the produced recording medium.

When the thickness of the resin layer in the invention exceeds 20 μm, the brittleness deteriorates in the produced recording medium, and thus fracture (brittle breakage) of the resin layer (and the layer provided on the resin layer) is likely to occur.

The “brittleness” as used in the invention refers to ease of fracture of a layer (e.g., ink receiving layer) when the recording medium (e.g., inkjet recording medium) is bent. The “reduced brittleness” as used in the invention refers to that the fracture of a layer when the recording medium is bent is suppressed.

From the viewpoint of achieving both improvements in image clarity and glossiness and a reduction in brittleness at the same time, the thickness of the resin layer is preferably from 2 μm to 15 μm and more preferably from 5 μm to 15 μm.

Hereinafter, the paper support and the resin layer constituting the recording medium support of the invention are described.

### Paper Support

The paper support in the invention is not particularly limited, and known paper media can be used.

The upper limit of the surface roughness SRa of the paper support of the invention is not particularly limited. From the viewpoint of forming a thin resin layer, the surface roughness SRa is preferably 0.40 μm or less and more preferably 0.25 μm or less.

The lower limit of the surface roughness SRa of the paper support of the invention is not particularly limited.

When the resin layer is formed by transfer described below, from the viewpoint of more effectively obtaining the effects obtained by transfer, the surface roughness SRa is preferably 0.10 μm or more and more preferably 0.15 μm or more.

In the above, the surface roughness SRa of the paper support refers to a value measured by the same method as that for measuring the surface roughness SRa of the resin layer described above.

Examples of the paper support in the invention include a base paper.

The base paper is not particularly limited, and examples include a base paper containing wood pulps as a main raw material, and is produced using, in addition to wood pulp, synthetic pulps, such as polypropylene, or synthetic fibers, such as nylon or polyester, as required.

Examples of the wood pulps include LBKP, LBSP, NBKP, NBSP, LDP NDP, LUKP, and NUKP, and it is preferable to use LBKP, NBSP, LBSP, NDP, and LDP containing short fibers in a high proportion. The proportion of LBSP and/or LDP is preferably 10 mass % to 70 mass %.

As the pulps, chemical pulps having less impurities (sulfate pulp or sulfite pulp) are preferably used, and pulps whose whiteness is increased by performing bleaching treatment are also useful.

To the base paper, sizing agents, such as higher fatty acids or alkyl ketene dimers, white pigments, such as calcium carbonates, talc, or titanium oxides, paper reinforcing agents, such as, starch, polyacrylamides, or polyvinyl alcohols, fluorescent brightening agents, moisture retention agents, such as polyethylene glycols, dispersants, and softening agents, such as quaternary ammonium, etc., can be added.

The freeness of the pulp to be used for paper making is preferably from 200 to 500 ml according to the stipulation of CSF. As the fiber length after beating, the sum of the mass % of a 24-mesh residue and the mass % of a 42-mesh residue as specified in JIS P-8207 is preferably from 30 to 70%. The 4-mesh residue is preferably 20 mass % or less.

The basis weight of the base paper is preferably from 30 to 250 g and particularly preferably from 50 to 200 g. The thickness of the base paper is preferably from 40 to 250 μm. It is also possible to give high flatness and smoothness to the base paper by subjecting to calendar treatment during or after paper making. The density of the paper is generally from 0.7 to 1.2 g/m² (JIS P-8118). The rigidity of the paper under the conditions stipulated by JIS P 8143 is preferably from 20 to 200 g.

A surface sizing agent may be applied onto the surface of the base paper. As the surface sizing agent, the same sizing agent that can be added to the base paper can be used.

The pH of the base paper measured by a hot water extraction method stipulated by JIS P 8113 is preferably from 5 to 9.

To the transfer surface (surface on which a resin layer is provided) of the paper support, a pigment coated layer may be provided.

Examples of components that can be added to the pigment coated layer include white pigments, aqueous binders, and other components.

Examples of the white pigments to be contained in the pigment coated layer include white inorganic pigments, such as precipitated calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, hydrated halloysite, magnesium carbonate, or magnesium hydroxide and organic pigments, such as a styrene-based plastic pigment, an acrylic plastic pigment, polyethylene, microcapsule, urea resin, or melamine resin.

Examples of the aqueous binders to be used in the pigment coated layer include water-soluble polymers, such as a styrene/maleate copolymer, a styrene/acrylate copolymer, polyvinyl alcohol, silanol-modified polyvinyl alcohol, starch, cationic starch, casein, gelatin, carboxymethylcellulose, hydroxyethylcellulose, or polyvinyl pyrrolidone and water-dispersible polymers, such as styrene butadiene latex or acryl emulsion.

Examples of other components to be contained in the pigment coated layer include defoaming agents, foam suppressing agents, dyes, fluorescent brightening agents, antiseptic agents, and water resistant agents.

Resin Layer

### Resin

Resins to be contained in the resin layer in the invention are not particularly limited, and examples include polymers having polar groups, such as a carboxylic acid (may be a salt of carboxylic acid) group in the side chain. Examples of such polymers include methacrylic acid copolymers, acrylic acid copolymers, itaconic acid copolymers, crotonic acid copolymers, maleic acid copolymers, and partially esterified maleic acid copolymers described in JP-A No. 59-44615, JP-B Nos. 54-34327, 58-12577, and 54-25957, and JP-A Nos. 59-53836 and 59-71048. Moreover, examples include cellulose derivatives having a carboxylic acid group in the side chain. In addition to the above, adducts of cyclic acid anhydrides to hydroxyl-containing polymers can be preferably used.

Particularly preferable examples include copolymers of benzyl (meth)acrylate and (meth) acrylic acid and multicomponent copolymers of benzyl(meth)acrylate, (meth)acrylic acid, and other monomers described in U.S. Pat. No. 4,139,391. Binder polymers having the polar groups may be used singly or in the form of a composition to be used in combination with general film forming polymers.

As resins to be contained in the resin layer, thermoplastic resins (e.g., thermoplastic resins having a softening point of 80° C. or less) are preferable.

Examples of the thermoplastic resins having a softening point of 80° C. or less include saponified products of ethylene and an acrylate copolymer, saponified products of styrene and a (meth)acrylate copolymer, saponified products of vinyl toluene and a (meth)acrylate copolymer, and saponified products of (meth)acrylate copolymers or the like of poly (meth) acrylate and butyl (meth)acrylate and vinyl acetate or the like.

For the thermoplastic resin layer, at least one member suitably selected from the thermoplastic resins mentioned above can be used. Furthermore, organic polymers having a softening point of about 80° C. or less according to “Plastic Seino Binran (Handbook of Properties of Plastic)”, Nihon Plastic Kogyo Renmei, edited by Zennippon Plastic Seikei Kogyo Rengokai, published by Kogyo Chosakai, Oct. 25, 1968) can be used.

Organic polymer substances having a softening point of 80° C. or higher can be used by reducing a substantial softening point to be 80° C. or less by adding, to the organic polymer substances, various plasticizers that are compatible with the polymer substances. To the organic polymer substances, various polymers, supercooled substances, adhesion improving agents, surfactants, release agents, etc., can also be added in order to adjust the adhesive strength with the temporary support insofar as the substantial softening point does not exceed 80° C.

Specific examples of preferable plasticizers include polypropylene glycol, polyethylene glycol, dioctyl phthalate, diheptylphthalate, dibutyl phthalate, tricresyl phosphate, cresyl diphenyl phosphate, and biphenyl diphenyl phosphate.

As resins to be contained in the resin layer, water-soluble resins may be used.

Examples of the water-soluble resins include a polyvinyl ether/maleic acid anhydride polymer, a water-soluble salt of carboxy alkyl cellulose, water-soluble cellulose ethers, a water-soluble salt of carboxy alkyl starch, polyvinyl alcohol, polyvinyl pyrrolidone, various polyacrylamides, various water-soluble polyamides, a water-soluble salt of polyacrylic acid, water-soluble salts of the group consisting of gelatin, an ethylene oxide polymer, various starches, and analogues thereof, a styrene/maleic acid copolymer, a maleinate resin, and combinations of two or more kinds thereof described in, for example, JP-A No. 46-2121 or JP-B No. 56-40824. Among the above, a combination of polyvinyl alcohol and polyvinyl pyrrolidone is particularly preferable.

Polyvinyl alcohols having a degree of saponification of 80% or more are preferable.

Resin Composition

The resin layer in the invention is preferably formed using resin compositions.

As the resin compositions, resin compositions containing the resins mentioned above and solvents (as required, surfactants) are preferable.

Solvent

Examples of the solvents include methyl ethyl ketone, propylene glycol monomethyl ether, propylene glycol monomethyl ether acetate, cyclohexanone, cyclohexanol, methyl isobutyl ketone, ethyl lactate, methyl lactate, and caprolactam.

Surfactant

In the resin composition, it is preferable to blend a suitable surfactant from the viewpoint that the thickness can be controlled to be a uniform film thickness and coating unevenness is effectively suppressed.

Examples of preferable surfactants include surfactants described in JP-A Nos. 2003-337424 and 11-133600.

The recording medium support of the invention described above is particularly preferable for the application of producing an inkjet recording medium by providing an ink receiving layer on a resin layer. The application of the recording medium support of the invention is not limited to the application of an inkjet recording medium. For example, the recording medium support of the invention is preferably used for the application of producing a heat-sensitive recording material by providing a heat-sensitive recording layer on the resin layer.

Hereinafter, a method for producing the recording medium support of the invention suitable is described.

Method for Producing a Recording Medium Support

A method for producing a recording medium support of the invention includes a process for forming a resin layer having a thickness of from 2 μm to 20 μm on a paper support by transferring a resin layer of a transfer material having the resin layer on a temporary support (hereinafter also referred to as a “transfer process”).

In the method described above, a contact surface of the resin layer with the temporary support in the transfer material functions as a surface (surface distant from the paper support) of the resin layer on the paper support after transferring. Therefore, when the thickness of the resin layer is 2 μm or more, the pattern of the surface of the temporary support of the transfer material is strongly reflected (transferred) to the surface of the resin layer on the paper support rather than the pattern (irregularities) of the surface of the paper support. Therefore, the flatness and smoothness of the surface of the resin layer on the paper support increase. For example, when a temporary support having a surface roughness SRa of 0.02 μm or less is used, a surface roughness SRa of the resin layer on the paper support can be adjusted to be 0.04 μm or less.

As described above, according to the method for producing the recording medium support of the invention, the flatness and the smoothness of the surface of the resin layer on the paper support increase. Therefore, the image clarity and the glossiness are improved in the inkjet recording medium produced using the recording medium support. Furthermore, since the thickness of the resin layer on the paper support is 20 μm or less, the brittleness decreases in the inkjet recording medium produced using the recording medium support.

Techniques for forming an ink receiving layer by transfer are already known. However, the production method of the invention is different from the former techniques in that the resin layer near the paper support rather than the ink receiving layer is formed by transfer. The production method has outstanding effects in terms of glossiness, image clarity, handling properties, and ink absorbency compared with the former techniques for forming the ink receiving layer by transfer.

Transfer Material

A transfer material in the invention has a resin layer on a temporary support.

As the temporary support, temporary supports having high flatness and smoothness of the surface, e.g., temporary supports having a surface roughness SRa of 0.08 μm or less (preferably 0.06 μm or less and particularly preferably 0.04 μm or less), are preferable.

Examples of the temporary supports include sheet-shaped temporary supports, such as resin films, and roll-shaped temporary supports. In particular, from the viewpoint of transfer properties, resin films are preferable.

The resin films can be suitably selected from resins composed of flexible substances that are chemically and thermally stable. Specific preferable examples include thin sheets, such as Teflon (registered trademark), polyethylene terephthalate, polycarbonate, polyethylene, polypropylene, or polyester or laminates thereof. The thickness of the temporary support is preferably from 5 to 300 μm and more preferably from 20 to 150 μm. When the thickness is within the range above, the temporary support can be easily separated in such a manner as not to break and exposure providing a favorable resolution can be performed even through the temporary support.

Among the specific examples above, a biaxially stretched polyethylene terephthalate film is particularly preferable.

On the resin layer in the transfer material, a thin cover sheet may be provided so as to protect the layer from contamination or breakage during storage. The cover sheet may contain the same or similar material as that of the temporary support, and is preferably easily separated from the resin layer.

As a cover sheet material, silicone paper or a polyolefin or polytetrafluoroethylene sheet is appropriate. The thickness of the cover sheet is generally from 4 to 40 μm, preferably from 5 to 30 μm, and particularly preferably from 10 to 25 μm.

The resin layer in the transfer material is the same as the resin layer in the recording medium support described above, and preferable materials and preferable film thicknesses are also the same.

Transfer Process

In the transfer process in the invention, a resin layer having a thickness of from 2 μm to 20 μm is formed on a paper support by transferring the resin layer of the transfer material onto the paper support.

It is preferable to perform transfer in the transfer process by thermocompression bonding. Hereinafter, an example of thermocompression bonding is described.

First, when a cover sheet is provided on the resin layer of the transfer material, the cover sheet is removed by separation.

Next, the surface of the resin layer is attached to the surface of the paper support, heated and pressurized through a laminator or the like, and multi-layered. Thus, a multi-layered element having a multi-layered structure of “Temporary support/Resin layer/Paper support” is obtained.

The laminator can be suitably selected from known laminators, vacuum laminators, and the like for use. In order to further improve productivity, an auto-cut laminator may be used.

Subsequently, the temporary support is removed from the multi-layered element by separating between the temporary support and the resin layer, thereby forming the resin layer on the paper support by transfer.

The heating conditions are preferably from 80° C. to 150° C. and more preferably from 100° C. to 140° C. from the viewpoint of transfer properties.

The pressure in the pressurization process is preferably a linear pressure of 50 N/cm to a linear pressure of 150 N/cm and more preferably a linear pressure of 70 N/cm to a linear pressure of 130 N/cm from the viewpoint of transfer properties.

The method for producing the recording medium support of the invention may have a transfer material production process for producing a transfer material before the transfer process. The transfer material can be produced by, for example, applying the resin composition described above onto the temporary support according to known methods, such as slit coating, and drying the same to form a resin layer (further pressing the cover sheet on the resin layer as required).

Inkjet Recording Medium

The inkjet recording medium of the invention has a resin layer having a thickness of from 2 μm to 20 μm and an ink receiving layer containing a pigment and a water-soluble resin in this order on a paper support and the center surface average roughness (SRa value) of the surface of the ink receiving layer provided on the paper support is 0.08 μm or less, provided that the SRa value is measured at a cutoff value of from 0.2 mm to 0.3 mm

The image clarity and the glossiness of the inkjet recording medium of the invention are improved when the center surface average roughness (SRa value) of the ink receiving layer is 0.08 μm or less and the thickness of the resin layer is 2 μm or more.

According to the inkjet recording medium of the invention, when the thickness of the resin layer is 20 μm or less, the brittleness of the ink receiving layer decreases.

In the inkjet recording medium of the invention, the resin layer under the ink receiving layer (side near the paper support) is thinner than the inkjet recording medium having the ink receiving layer on the WP paper described above. Therefore, the productivity, recycling properties, and texture as paper are excellent.

When the center surface average roughness (SRa value) of the ink receiving layer provided on the paper support exceeds 0.08 μm, the image clarity and the glossiness deteriorate.

Here, the center surface average roughness (SRa value) of the ink receiving layer provided on the paper support (hereinafter also referred to as a “surface roughness SRa of an ink receiving layer”) refers to a value obtained by measuring the surface of the ink receiving layer provided on the paper support by the same method as that for measuring the surface roughness SRa of the resin layer described above.

From the viewpoint of further improving the image clarity and glossiness of the inkjet recording medium (ink receiving layer), the surface roughness SRa of the ink receiving layer is preferably 0.06 μm or less and more preferably 0.05 μm or less.

Methods for achieving the surface roughness SRa of the ink receiving layer in the invention are not particularly limited. For example, a method for forming a resin layer functioning as a base of the ink receiving layer by transferring the resin layer of the transfer material onto the paper support, and forming the ink receiving layer on the formed resin layer (e.g., a method for producing an inkjet recording medium of the invention described below) is preferable.

In particular, the method for forming the ink receiving layer on the recording medium support of the invention described above is preferable.

As the paper support and the resin layer, the paper support and the resin layer described in the description of the recording medium support above can be used.

Hereinafter, the ink receiving layer of the inkjet recording medium of the invention is described.

Ink Receiving Layer

The ink receiving layer in the invention contains a pigment and a water-soluble resin.

The ink receiving layer may have a single layer structure or a structure of two or more layers.

From the viewpoint of more effectively achieving the effects of the invention, the layer thickness of the ink receiving layer (total thickness in the case of two or more layers) is preferably from 10 μm to 60 μm and more preferably from 10 μm to 40 μm.

Pigment

Pigments in the invention are not particularly limited, and, for example, inorganic particles can be preferably used.

Examples of the inorganic particles include silica particles, colloidal silica, titanium dioxide, barium sulfate, calcium silicate, zeolite, kaolinite, halloysite, mica, talc, calcium carbonate, magnesium carbonate, calcium sulfate, boehmite alumina, and pseudo boehmite alumina. In particular, silica particles or pseudo boehmite alumina are/is preferable.

The inorganic particles may be used singly or in combination of two or more kinds thereof.

Silica Fine Particles

Because the silica fine particles have a particularly large specific surface area, the silica fine particles have high ink absorptivity and high efficiency of ink retention. Further, because the silica fine particles have a low refraction index, when dispersion is carried out to an extent that an appropriate fine particle diameter is obtained, the ink receiving layer may be made transparent, and there is an advantage that high color density and satisfactory coloring property are obtained. As such, the fact that the ink receiving layer is transparent is important from the viewpoint of obtaining high color density, satisfactory coloring property, and satisfactory glossiness, for example, in the case of application to recording sheets such as photographic glossy paper and the like.

The average primary particle diameter of the silica fine particles is preferably 20 nm or less, more preferably 15 nm or less, and particularly preferably 10 nm or less. When the average primary particle diameter is 20 nm or less, ink absorbing characteristics may be effectively improved and, at the same time, glossiness of the surface of the ink receiving layer may be enhanced.

The specific surface area of the silica fine particles measured by BET method is preferably 200 m²/g or more, more preferably 250 m²/g or more, and particularly preferably 380 m²/g or more. When the specific surface area of the silica fine particles is 200 m²/g or more, the ink receiving layer has high transparency and can maintain high print density.

The BET method as referred to in the present description is a method for measuring a surface area of a powder by a vapor-phase adsorption method. This method finds a total surface area of 1 g of a sample, that is, a specific surface area from an adsorption isotherm. Nitrogen gas is most often used as an adsorption gas, and the adsorbed amount of gas is most often measured from the pressure or volume variations of an adsorbed gas. An equation suggested by Brunauer, Emmett, and Teller, which is called a BET equation, is the most famous equation representing an isotherm of multi-molecular adsorption and it is widely used for determining the surface area. A surface area can be found by finding the adsorption amount based on the BET equation and multiplying by the area taken by one adsorbed molecule on the surface.

Because the silica fine particles, in particular, have silanol groups on their surfaces, the particles easily adhere to each other through hydrogen bonding of the silanol groups, and there is an effect of adhesion between the particles through the silanol groups and the water-soluble resin. Hence, when the average primary particle diameter of the silica fine particles is 20 nm or less as described above, the porosity of the ink receiving layer is high, a structure with high transparency can be formed, and ink absorbing characteristics can be effectively improved.

Silica fine particles are usually roughly classified into wet method particles and dry method (vapor-phase process) particles in accordance with the method for manufacturing thereof. Of the wet methods, the mainstream is a method of generating activated silica by acid decomposition of a silicate, appropriately polymerizing the activated silica, and aggregation-precipitating the resulting polymeric silica, thereby obtaining hydrated silica. On the other hand, a mainstream vapor-phase process is a method of producing anhydrous silica particles by either a method of conducting high-temperature vapor-phase hydrolysis of a silicon halide (flame hydrolysis process), or a method of conducting reductive heating and vaporization of quartz sand and coke in an electric furnace, applying an arc discharge and oxidizing the vaporized silica with air (arc method). The “vapor-phase process silica” refers to an anhydrous silica fine particle produced by the vapor-phase process.

The vapor-phase process silica is different from the hydrated silica in terms of the density of silanol groups on the silica surface, the presence of pores, and the like, so that these different types of silica show different properties to each other. The vapor-phase process silica is suitable for forming a three dimensional structure having high porosity. The reason for this is unclear. However, it is presumed that in the case of the hydrated silica, the density of the silanol groups on the surface of the fine particles is as high as 5 to 8 per nm², so that the silica fine particles are easy to aggregate densely and, in contrast, in the case of the vapor-phase process silica, the density of the silanol groups on the surface of the fine particles is as low as 2 to 3 per nm², so that the silica fine particles form a thin flocculate, which results in a structure having a high porosity.

In the present invention, vapor-phase process silica fine particles (anhydrous silica) that can be obtained by the dry method are preferable, and silica fine particles having a density of silanol groups on the surface at from 2 per nm² to 3 per nm² are more preferable.

The inorganic fine particles most preferably used in the present invention are vapor-phase process silica having a specific surface area of 200 m²/g or more as determined by the BET method.

Pseudo-Boehmite Alumina

The pseudo-boehmite alumina (pseudo-boehmite alumina hydrate) is represented by the following structural formula:

Al₂O₃.nH₂O(1<n<3)

and means an alumina hydrate in which n is more than 1 but less than 3 in the structural formula.

The average pore radius of the pseudo boehmite alumina is preferably from 1 to 10 nm and particularly preferably from 2 to 7 nm from the viewpoint of achieving good ink absorption rate of the ink receiving layer. When the average pore radius is within the range, the ink absorbency is favorable, the fixation of dyes in ink is favorable, and the occurrence of image bleeding can also be avoided.

The pore volume of the pseudo boehmite alumina is preferably in the range of 0.1 to 0.8 ml/g and particularly preferably in the range of 0.4 to 0.6 ml/g from the viewpoint of achieving a favorable ink absorption capacity of the ink receiving layer. When the pore volume of the ink receiving layer is within the range above, the occurrence of cracks or powder dropping in the ink receiving layer can be inhibited, thereby achieving favorable ink absorption. The pore volume in a pore radius of 2 nm to 10 nm is preferably 0.1 ml/g or more. When the pore volume is within the range, the adsorption of dyes in ink becomes favorable. The solvent absorption amount per unit area of the ink receiving layer is preferably 5 ml/m² or more and particularly preferably 10 ml/m² or more. When the solvent absorption amount per unit area of the ink receiving layer is within the range above, ink overflow particularly when multicolor printing is performed can be prevented.

In order to sufficiently absorb dyes in ink to fix the same, the BET specific surface area of the pseudo boehmite alumina is preferably in the range of 70 to 300 m²/g. When the BET specific surface area is in the range above, the pseudo boehmite alumina can be favorably dispersed and also the fixing efficiency of dyes in ink becomes favorable without inclination of pore volume distribution, and image bleeding can also be inhibited.

In order to increase the concentration of the pseudo boehmite alumina in a dispersion liquid thereof, the number of surface hydroxyl group of the pseudo boehmite alumina is preferably 10²⁰ pieces/g or more. When the number of the surface hydroxyl group is small, the pseudo boehmite alumina is likely to agglomerate, which makes it difficult to increase the concentration of the dispersion liquid.

In order to stabilize the dispersion liquid of the pseudo boehmite alumina, various acids are usually added to the dispersion liquid. Examples of such acids include nitric acid, hydrochloric acid, hydrobromic acid, acetic acid, formic acid, ferric chloride, and aluminum chloride, but the invention is not limited thereto.

The pseudo boehmite alumina can be produced by known methods, such as hydrolysis of aluminum alkoxides, such as aluminum isopropoxide, neutralization of aluminium salts by alkali, or hydrolysis of aluminate. The particle diameter, pore diameter, pore volume, specific surface area, number of surface hydroxyl group, and the like of the pseudo boehmite alumina can be controlled by a precipitation temperature, maturing time, liquid pH, liquid concentration, coexistence salts, etc.

For example, JP-A Nos. 57-88074, 62-56321, 4-275917, 6-64918, 7-10535, and 7-267633, U.S. Pat. No. 2,656,321, and Am. Ceramic Soc. Bull., 54, 289 (1975) disclose a method for hydrolyzing aluminum alkoxides. Examples of the aluminum alkoxides include isopropoxide, propoxide, and 2-butoxide. According to the method, pseudo boehmite alumina having very high purity can be obtained.

In addition to the above, as a method for obtaining the pseudo boehmite alumina, a method for obtaining the pseudo boehmite alumina using mineral salts of aluminum or hydrates thereof as a raw material is common as described in, for example, JP-A No. 54-116398, 55-23034, 55-27824, or 56-120508. Examples of the mineral salts include mineral salts, such as aluminum chloride, aluminum nitrate, aluminum sulfate, polyaluminum chloride, ammonium alum, sodium aluminate, potassium aluminate, or aluminum hydroxide and hydrates of these mineral salts.

Specifically, the pseudo boehmite alumina can be produced by a neutralization reaction of acidic aqueous aluminum salt solutions of aluminum sulfate, aluminum nitrate, aluminum chloride, or the like, and basic aqueous solutions of sodium aluminate, sodium hydroxide, ammonia water, or the like. In this case, it is general that the solutions are mixed so that the amount of the pseudo boehmite alumina produced in the liquid does not exceed 5 mass % and are reacted under the conditions of a pH of 6 to 10 and a temperature of 20 to 100° C. Moreover, the pseudo boehmite alumina can also be produced by a method for growing crystals of a pseudo boehmite alumina by alternately fluctuating the pH to the acid side and base side described in JP-A No. 56-120508, a method for mixing a pseudo boehmite alumina obtained from a mineral salt of aluminum and alumina obtained by Bayer process, and rehydrating alumina, described in JP-B No. 4-33728, etc.

The average particle diameter of the primary particles (average primary particle diameter) of the pseudo boehmite alumina is preferably from 5 to 50 nm. In order to obtain higher glossiness, it is preferable to use tabular particles having an average primary particle diameter of 5 to 20 nm and an average aspect ratio (ratio of average particle diameter to average thickness) is 2 or more.

As the average primary particle diameter of the pseudo boehmite alumina, the nominal value of commercial item manufacturers may be used.

The average primary particle diameter can be measured from the produced recording medium by cutting out the ink receiving layer, removing resin components by hot water, collecting or the like only particles by centrifugal separation, and then observing the obtained particles under TEM (transmission electron microscope). In this case, for example, a standard sample in which only a coating liquid for ink receiving layer is applied on a support is subjected to the same treatment. Then, the measurement value (average) is compared with a known particle diameter (nm) of the used pseudo boehmite alumina particles. Then, the measurement value (average) in the produced recording medium is proportionally calculated from the differences between the values obtained by the comparison and converted, thereby determining the average primary particle diameter in the produced recording medium. In order to determine the average primary particle diameter, about 100 to 3000 particles are required as the number of measurement particles.

The content of the pseudo boehmite alumina is preferably from 10 to 20 mass % and more preferably from 12 to 18 mass % in the ink receiving layer (or the coating liquid for ink receiving layer). By adjusting the content of the pseudo boehmite alumina in the range above, the transparency of the layer becomes high and the transparency after printing also increases, thereby obtaining a high density.

Water-Soluble Resin

The ink receiving layer in the invention contains at least one water-soluble resin.

Examples of the water-soluble resin include polyvinyl alcohol (including modified polyvinyl alcohols, such as acetoacetyl-, carboxy-, itaconic acid-, maleic acid-, silica-, or amino group-modified polyvinyl alcohol), methylcellulose, carboxymethylcellulose, starches (including modified starches), gelatin, gum arabic, casein, styrene-maleic anhydride copolymer hydrolyzates, polyacrylamides, and saponified products of a vinyl acetate-polyacrylic acid copolymer. Moreover, examples of the water-soluble resin include latex binders of synthetic polymer, such as a styrene/butadiene copolymer, a vinyl acetate copolymer, an acrylonitrile/butadiene copolymer, a methyl acrylate/butadiene copolymer, or polyvinylidene chloride.

Polyvinyl Alcohol

Examples of the polyvinyl alcohol include polyvinyl alcohol obtained by saponifying a lower alcohol solution of polyvinyl acetate and derivatives thereof, and further saponified products of copolymers of vinyl acetate and monomers that can be copolymerized with vinyl acetate. Here, examples of the monomers that can be copolymerized with vinyl acetate include unsaturated carboxylic acids and esters thereof, such as (anhydrous) maleic acid, fumaric acid, crotonic acid, itaconic acid, or (meth)acrylic acid; α-olefins, such as ethylene or propylene; olefin sulfonic acids, such as (meth)allylsulfonic acid, ethylene sulfonic acid, or sulfonic acid malate; alkali salts of olefinsulfonic acid, such as sodium (meth)allylsulfonate, sodium ethylenesulfonate, sodium sulfonate (meth)acrylate, sodium sulfonate(monoalkyl malate), or sodium disulfonate alkyl malate; amide group-containing monomers, such as N-methylolacrylamide or alkali salts of acrylamide alkylsulfonate; and N-vinylpyrrolidone derivatives.

Among the polyvinyl alcohols, polyvinyl alcohols having a degree of saponification of 92 to 98 mol % (hereinafter sometimes referred to as a “highly saponified polyvinyl alcohol”) are particularly preferable.

When the degree of saponification of polyvinyl alcohol is 92 mol % or more, a more favorable halftone color can be obtained, an increase in viscosity of a coating liquid can be effectively suppressed, and more favorable coating stability can be obtained.

In contrast, when the degree of saponification of polyvinyl alcohol is 98 mol % or less, ink absorbency can be further improved.

The degree of saponification of polyvinyl alcohol is more preferably from 93 to 97 mol %.

The degree of polymerization of the highly saponified polyvinyl alcohol is preferably from 1500 to 3600 and more preferably from 2000 to 3500. When the degree of polymerization is 1500 or more, cracks of the ink receiving layer can be more effectively suppressed. When the degree of polymerization is 3600 or less, an increase in the viscosity of a coating liquid can be more effectively suppressed.

In the invention, water-soluble resins other than the highly saponified polyvinyl alcohol as the water-soluble resin can also be used in combination with the polyvinyl alcohol. Examples of the water-soluble resin that can be used in combination include resins having a hydroxyl group as a hydrophilic structural unit, such as polyvinyl alcohol (PVA) having a degree of saponification outside the range mentioned above, cation-modified polyvinyl alcohol, anion-modified polyvinyl alcohol, silanol-modified polyvinyl alcohol, polyvinyl acetal, cellulose resin [methylcellulose (MC), ethyl cellulose (EC), hydroxyethylcellulose (HEC), carboxymethylcellulose (CMC), hydroxypropylcellulose (HPC), etc.], chitins, chitosans, or starch; resins having a hydrophilic ether linkage, such as polypropylene oxide (PPO), polyethylene glycol (PEG), or polyvinyl ether (PVE); and resins having a hydrophilic amide group or amide linkage, such as polyacrylamide (PAAM) or polyvinyl pyrrolidone (PVP). Moreover, examples of the water-soluble resin include resins having a carboxyl group as a dissociative group, such as polyacrylate, maleic acid resin, alginate, or gelatins.

The proportion of the highly saponified polyvinyl alcohol relative to the total amount of the highly saponified polyvinyl alcohol and the water-soluble resin mentioned above when the highly saponified polyvinyl alcohol and the water-soluble resin mentioned above are used in combination is preferably from 1 to 30 mass %, more preferably from 3 to 20 mass %, and particularly preferably from 6 to 12 mass %.

The content of the highly saponified polyvinyl alcohol is preferably 9 to 40 mass % and more preferably 12 to 33 mass % relative to the total solid content mass of the ink receiving layer from the viewpoint of preventing a reduction in film strength or the occurrence of cracks during drying arising from an excessively low content of the highly saponified polyvinyl alcohol and preventing a reduction in ink absorbency arising from a reduction in porosity occurring when the pores are likely to be blocked with resin arising from an excessively high content of the highly saponified polyvinyl alcohol.

The polyvinyl alcohol resins have hydroxyl groups in their respective structural units, and hydrogen bonds are formed between these hydroxyl groups and silanol groups present on the surfaces of the silica; as a result, it becomes easy to form a three-dimensional network structure having secondary particles of silica fine particles as chain units. It is thought that formation of such a three-dimensional network structure allows the ink receiving layer formed to have a porous structure of a high porosity.

In the inkjet recording medium, the porous ink receiving layer formed in the foregoing manner can quickly absorb ink through capillary action and form good dots of high circularity without causing ink bleeding.

Ratio of Pigment Content to Water-Soluble Resin Content

In the ink receiving layer, the ratio of the pigment content (x) by mass to the water-soluble resin content (y) by mass [PB ratio (x/y): a mass of a pigment per one part by mass of a water-soluble resin] may substantially affect the film structure of the ink receiving layer. The larger the PB ratio is, the lager porosity, the bigger volume of fine pore, and the bigger surface area (per mass unit) of the ink receiving layer may be obtained. Specifically, the PB ratio (x/y) is preferably in a range of from 1.5/1 to 10/1 from the viewpoints of preventing a decrease in film strength and the appearance of cracks under drying, which are caused by excessively high PB ratios, and suppressing a reduction in ink absorptivity by a decrease in porosity resulting from a tendency to pores being clogged by the resins, which develops when PB ratios are excessively low.

At the time of passage through the transfer system of an inkjet printer, the inkjet recording medium is subjected to stress in some cases, so that the ink receiving layer is required to have sufficient film strength. In addition, from the standpoint of avoiding the occurrence of cracking and exfoliation in the ink receiving layer when the recording medium is cut into sheets, the ink receiving layer is required to have sufficient film strength. In view of these cases, the PB ratio (x/y) is preferably 5/1 or less, while it is preferably 2/1 or more from the viewpoint of ensuring quick ink absorptivity in inkjet printer.

For example, when a coating liquid prepared by completely dispersing vapor-phase process silica fine particles having an average primary particle diameter of 20 nm or less and polyvinyl alcohol resins with a high saponification degree at a mass ratio (x/y) of 2/1 to 5/1 in an aqueous solution is applied onto a support and dried, a three-dimensional network structure is formed having secondary particles of the silica fine particles as chain units, whereby a light-transmitting porous film having an average pore diameter of 30 nm or less, a porosity of 50% to 80%, a specific pore volume of 0.5 ml/g or more, and a specific surface area of 100 m²/g or more can be easily formed.

Other Components

The ink receiving layer of the invention may contain, as additional components other than the components described above, cross linking agents (e.g., boric acid), water-soluble aluminum compounds (e.g., basic polyaluminum hydroxide (basic polyaluminum chloride)), zirconium compounds (e.g., zirconyl acetate), cation-modified self-emulsification polymers (e.g., cationic polyurethane), mordants (e.g., cationic polymers), surfactants, or the like. Furthermore, the ink receiving layer may contain various additives, such as a UV absorber, a fluorescent brightening agent, an antioxidant, or a browning inhibitor.

As these components, known components described in Paragraphs 0018 to 0082 of JP-A No. 2007-223119 or Paragraphs 0017 to 0082 of JP-A No. 2008-246755 can be used without particular limitation.

Method for Producing Inkjet Recording Medium

The method for producing an inkjet recording medium of the invention includes a process for forming a resin layer having a thickness of from 2 μm to 20 μm on a paper support by transferring a resin layer of a transfer material having the resin layer on a temporary support (hereinafter also referred to as a “resin layer formation process”) and a process for forming an ink receiving layer containing a pigment and a water-soluble resin on the resin layer formed on the paper support (hereinafter also referred to as an “ink receiving layer formation process”).

According to the method described above, the flatness and smoothness on the surface of the resin layer on the paper support increase as described in the description in the “Method for producing a recording medium support” above, and thus the image clarity and the glossiness of the ink receiving layer formed on the resin layer are improved. Furthermore, since the thickness of the resin layer on the paper support is 20 μm or less, the brittleness of the ink receiving layer is reduced with reduction of brittleness of the resin layer.

As the resin layer formation process, the method for producing a recording medium support of the invention described above can be applied as it is.

Method for Forming Ink Receiving Layer

There is no particular limitation on the method for forming the ink receiving layer, and, for example, a known method, in which a coating liquid for an ink receiving layer containing each of the components of the ink receiving layer described above and a solvent such as water or the like is coated on a resin layer and dried, may be used.

Preparation of the coating liquid for an ink receiving layer may be carried out by adding all of the components at the same time, or may be carried out by first preparing a pigment dispersion containing a pigment, and then adding the other components to the prepared pigment dispersion.

The ink receiving layer forming step may be carried out by coating one coating liquid containing all of the components and then drying, or may be carried out by coating two or more coating liquids from each other and then drying. In the latter case, the two or more coating liquids are prepared by dividing the components of the ink receiving layer among the two or more coating liquids, and then the two or more coating liquids are subjected to successive coating or simultaneous multilayer coating, followed by drying. Concerning the method of coating two or more coating liquids, there may be used, other than the successive coating and simultaneous multilayer coating, for example, “Wet-On-Wet method” described in paragraphs [0016] to [0037] in JP-A No. 2005-14593.

Examples of a disperser to be used for dispersing the pigment include various kinds of conventionally known dispersers such as a high speed rotating type disperser, a medium stirring type disperser (for example, a ball mill, a bead mill a sand mill, or the like), a ultrasonic disperser, a colloid mill disperser and a high pressure disperser. In order to efficiently disperse lumpy particles which generate during dispersion, a medium stirring type disperser, a colloid mill disperser, or a high pressure disperser (homogenizer) is preferable. Mainly, a medium stirring type disperser such as a bead mill is preferably used as the disperser, but from the viewpoints of acceleration of fine graining and high maximum density, high pressure homogenizer (for example, ULTIMIZER (trade name), manufactured by Sugino Machine Limited) is particularly preferable.

As a solvent used in preparation of a coating liquid for an ink receiving layer, water, an organic solvent, or a mixed solvent thereof may be used. Examples of the organic solvent include alcohols such as methanol, ethanol, n-propanol, i-propanol or methoxy propanol, ketones such as acetone or methyl ethyl ketone, tetrahydrofuran, acetonitrile, ethyl acetate, and toluene.

Method available for applying the coating solution for an ink receiving layer, include methods known in the art such as using an extrusion die coater, air doctor coater, blade coater, rod coater, knife coater, squeeze coater, reverse roll coater and bar coater.

The coating described above may be carried out by inline-mixing an aqueous solution of basic polyaluminum hydroxide with the coating liquid for the ink receiving layer.

A method for drying the coated layer obtained by the above coating, a known method of drying by blowing a dry air can be used without any particular limitation.

The present invention will be further described below in detail with reference to the examples, but it should be construed that the invention is in no way limited to these examples as long as not departing from the scope of the present invention. Note that, the terms “part”, “%”, and “molecular weight” respectively refer to as “part by mass”, “% by mass”, and “weight average molecular weight”, unless otherwise noted.

### Example 1

### Production of Support

50 parts of LBKP containing acacia and 50 parts of LBKP containing aspen were individually beaten by a disc refiner so that the freeness in terms of the Canadian Standard Freeness became 300 ml, thereby obtaining a pulp slurry.

To the obtained pulp slurry above, 1.3% (relative to the pulp) of cationic starch (CAT0304L (trade name, manufactured by Japan NSC)), 0.15% (relative to the pulp) of anionic polyacrylamide (POLYACRON ST-13 (trade name, manufactured by Seiko Chemicals, Co., Ltd.)), 0.29% (relative to the pulp) of alkylketene dimer (SIZEPINE K(trade name, manufactured by Arakawa Kagaku Kogyo Co., Ltd.)), 0.29% (relative to the pulp) of epoxidated behenic acid amide, 0.32% (relative to the pulp) of polyamide polyamine epichlorohydrin (ARAFIX 100 (trade name, manufactured by Arakawa Kagaku Kogyo Co., Ltd.)), were added, and then 0.12% (relative to the pulp) of a defoaming agent was added.

The pulp slurry prepared as described above was subjected to paper making with a Fortlinear paper machine, and dried by adjusting the tensile strength of a dryer canvas to 1.6 kg/cm in a process of drying while pressing a felt surface of a web against a drum dryer cylinder via dryer canvas. Thereafter, 1 g/m² of polyvinyl alcohol (KL-118 (trade name, manufactured by Kuraray Co., Ltd.)) was applied to both sides of a base paper by a size press, and a resultant base paper was subjected to calendar treatment.

Thus, a base paper having a basis weight of 157 g/m² and a thickness of 157 μm was obtained.

The surface roughness SRa of the obtained base paper was 0.20 μm when measured under the same conditions as those in the measurement of the surface roughness SRa of a resin layer described below.

Production of Transfer Material

### Preparation of Coating Liquid for Resin Layer

37 g of methyl ethyl ketone, 462 g of the following binder, and 0.59 g of the following surfactant were weighed, added in this order at a temperature of 25° C. (±2° C.), and agitated for 30 minutes at 150 rpm, thereby preparing a coating liquid for resin layer (intermediate layer).

| | |
|---|---|
| Binder | |
| Polymer (Random copolymer of benzyl methacrylate/methacrylic acid (= 78/22 [molar | 27% |
| ratio]), molecular weight of 38,000) | |
| Propylene glycol monomethyl ether acetate | 73% |
| Surfactant | |
| Following structure 1 | 30% |
| Methyl ethyl ketone | 70% |
| Structure 1 | |
| 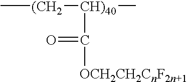 | |
| 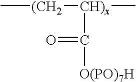 | |
| 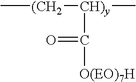 | |

(n = 6, x = 55, v = 5, Mw = 33940, Mw/Mn = 2.55
PO: Propylene oxide, EO: Ethylene oxide

Production of Transfer Material

A 75 μm thick polyethylene terephthalate film temporary support (PET temporary support) was prepared. The surface roughness SRa of the PET temporary support was 0.01 μm when measured under the same conditions as those in the measurement of the surface roughness SRa of the resin layer described below.

Next, the coating liquid for resin layer prepared above was applied using a slit-shaped nozzle to the side of the PET temporary support whose surface roughness SRa was measured, and then dried, thereby forming a resin layer having a film thicknesses of 7 μm.

Thus, a transfer material in which the PET temporary support and the resin layer (intermediate layer) were integrated was obtained.

Production of Recording Medium Support

The transfer material and the base paper were bonded to each other so that the surface of the resin layer of the transfer material and the front surface (surface opposite to a wire surface) of the base paper contact, and then laminated under the conditions of a rubber roller temperature of 130° C., a linear pressure of 100 N/cm, and a conveying speed of 2.2 m/min using a laminator ((Lamic II model) (trade name, manufactured by Hitachi Industries)).

Thus, a multilayer element having a layer structure of “Temporary support/Resin layer/Base paper” was obtained.

Next, the polyethylene terephthalate temporary support was removed from the multilayer element by separating the temporary support at the interface between the temporary support and the resin layer.

Thus, the resin layer was formed on the front surface of the base paper.

Furthermore, the resin layer was also formed on the rear surface (wire faces) of the base paper in the same manner as above.

Thus, a recording medium support having a layer structure of “Resin layer/Base paper/Resin layer” was obtained.

Preparation of Coating Liquid for Ink Receiving Layer

Following to the “Composition of silica dispersion liquid” described below, silica particles were mixed in a liquid in which a dimethyl diallyl ammonium chloride polymer (SHAROLL DC902P (trade name, manufactured by DAI-ICHI KOGYO SEIYAKU Co., Ltd.)) was mixed in ion exchange water, and further a slurry to which ZIRCOSOL ZA-30 (trade name, manufactured by DAIICHI KIGENSO KAGAKU KOGYO CO., LTD.) was added was dispersed at 170 MPa by an ULTIMIZER (trade name), manufactured by SUGINO MACHINE LIMITED, thereby preparing a silica dispersion liquid having a median size (average particle diameter) of 120 nm.

To the obtained silica dispersion liquid, ion exchange water, 7.5% boric acid liquid, SC-505, a polyvinyl alcohol solution, and SUPER FLEX 650-5 (trade name) were successively added and mixed according to the composition of a coating liquid for ink receiving layer described below, thereby producing a coating liquid for ink receiving layer.

Composition of Silica Dispersion Liquid

| | | |
|---|---|---|
| (1) | Vapor phase process silica particles (AEROSIL300SF75 | 15.0 parts |
| | (trade name, manufactured by Japan Aerosil Co.)) | |
| (2) | Ion exchange water | 82.9 parts |
| (3) | “SHAROLL DC-902P” (51.5% solution) (trade name, | 1.31 parts |
| | manufactured by DAI-ICHI KOGYO SEIYAKU | |
| | CO., LTD., dispersant) | |
| (4) | Zirconyl acetate “ZIRCOSOL ZA-30 (50% solution)” | 0.81 parts |
| | (trade name, manufactured by DAIICHI KIGENSO | |
| | KAGAKU KOGYO CO., LTD.) | |

Composition of Coating Liquid for Ink Receiving Layer

| | | |
|---|---|---|
| (1) | Silica dispersion liquid | 59.5 parts |
| (2) | Ion exchange water | 7.8 parts |
| (3) | 7.5% boric acid liquid (cross linking agent) | 4.4 parts |
| (4) | Dimethylamine/epichlorohydrin/polyalkylene | 0.1 parts |
| | polyamine polycondensate (50% solution) (SC-505 | |
| | (trade name, manufactured by HYMO Co., Ltd.)) | |
| (5) | Polyvinyl alcohol solution of the following | 26.0 parts |
| | composition | |
| (6) | Cation-modified polyurethane (SUPERFLEX 650-5 | 2.2 parts |
| | (25% liquid)) (trade name, manufactured by | |
| | DAI-ICHI KOGYO SEIYAKU CO., LTD.) | |

Composition of Polyvinyl Alcohol Solution

| | | |
|---|---|---|
| (1) | Polyvinyl alcohol (“JM-33” (trade name, manufactured | 6.96 parts |
| | by JAPAN VAM & POVAL CO., LTD., Degree of | |
| | saponification of 94.3 mol %, Degree of | |
| | polymerization of 3300) | |
| (2) | Polyoxyethylene lauryl ether (EMULGEN 109P | 0.23 parts |
| | (trade name), manufactured by | |
| | Kao Corp., surfactant) | |
| (3) | Diethylene glycol monobutyl ether (BUTYCENOL | 2.12 parts |
| | 20P (trade name, manufactured by Kyowa | |
| | Hakko Chemical Co., Ltd.)) | |
| (4) | Ion exchange water | 90.69 parts |

Formation of Ink Receiving Layer

The surface of the resin layer of the recording medium support was subjected to corona discharge treatment. Thereafter, in-line blending of a PAC liquid of the following composition was performed in 132 g/m² of the coating liquid for ink receiving layer, and applied to the surface of the resin layer of the recording medium support by extrusion die coater so that the coating amount was 9.2 g/m². Thereafter, the resultant coating was treated with a cold air dryer for 5 minutes at 5° C. and a relative humidity of 30% (air velocity of 3 to 8 m/sec), and thereafter further dried for 20 minutes by dry air at a temperature of 25° C. and a relative humidity of 25% (air velocity of 3 to 8 m/sec). Thus, the ink receiving layer was formed on the resin layer.

Thus, an inkjet recording medium (inkjet recording sheet) in which the ink receiving layer having a dry film thickness of 28 μm was provided on the resin layer of the recording medium support was obtained.

Composition of PAC Liquid

| | | |
|---|---|---|
| (1) | Aqueous polyaluminum chloride solution having a degree | 20 parts |
| | of basicity of 83% (ALFINE 83 (trade name, | |
| | manufactured by TAIMEL CHEMICALS CO., LTD.)) | |
| (2) | Ion exchange water | 80 parts |

Measurement and Evaluation

The recording medium support and the inkjet recording medium were subjected to the following measurement and evaluation. The results of the measurement and evaluation are shown in Table 1.

Measurement of Surface Roughness SRa

The surface roughness SRa of the resin layer of the recording medium support was measured using NEW VIEW 5022 (trade name, manufactured by Zygo) at a cutoff value of from 0.2 mm to 0.3 mm.

The surface roughness SRa of the ink receiving layer of the inkjet recording medium was measured by the same method.

Evaluation of Image Clarity

The image clarity of the surface of the ink receiving layer of the inkjet recording medium was evaluated as follows.

More specifically, the image clarity of the surface of the ink receiving layer was measured based on the following measurement conditions using an image clarity meter ICM-1 (trade name, manufactured by Suga Test Instruments Co., Ltd.) according to an image clarity test method specified in JIS H 8686-2 (1999).

Measurement Conditions

Measurement method: reflection

Measurement angle: 60°

Optical comb: 2.0 mm

Evaluation Criteria

A: Image clarity of 90% or more
B: Image clarity of 70% or more and less than 90%
C: Image clarity of 30% or more and less than 70%
D: Image clarity of less than 30%

Glossiness

The glossiness of the surface of the ink receiving layer of the inkjet recording medium was measured using a digital deformation glossimeter UGV-5D (trade name, manufactured by a Suga Test Instruments Co., Ltd., measurement aperture of 8 mm) at an incident angle of 60° and a light receiving angle of 60°.

Evaluation Criteria

A: Glossiness of 40% or more
B: Glossiness of 20% or more and less than 40%
C: Glossiness of less than 20%

Brittleness

The inkjet recording medium was stored for 1 day in an air-conditioned room having a temperature of 25° C. and a relative humidity of 50%, and thereafter wound around a cylinder having a diameter of 20 mmφ with the ink receiving layer outside. Then, the brittleness was evaluated.

It was judged that the brittleness was improved in the case of A and B in the following criteria.

### Evaluation Criteria

A: No fracture was observed in the ink receiving layer.
B: Although slight fracture was observed in the ink receiving layer, which causes no problems in practical use.
C: Large fracture was observed in the ink receiving layer.

### Example 2

### Preparation of Alumina White Transparent Dispersion Liquid

708 g of CATALOID AP-5 (trade name, manufactured by Catalysts & Chemicals Ind. Co., Ltd.; pseudo boehmite alumina hydrate) was added to 2042 g of ion exchange water while being agitated with a dissolver, thereby obtaining a white coarse dispersion liquid of alumina. The rotation number of the dissolver was 3000 r.p.m. and the rotation duration was 10 minutes.

Subsequently, the alumina coarse dispersion liquid was finely dispersed by using a high pressure dispersing machine (ULTIMIZER HJP25005 (trade name, manufactured by Sugino Machine Limited)) to obtain a white transparent alumina dispersion liquid (alumina white transparent dispersion liquid) with a solid content of 25%. In this case, the pressure was 100 MPa and the ejection amount was 600 g/min.

The obtained alumina white transparent dispersion liquid was adjusted to have a liquid temperature of 30° C., and diluted with ion exchange water so that the transmittance measured by LA-920 (trade name, manufactured by Horiba, Ltd.) was 80%. Then, the particle diameter of the dispersed particles was measured by LA-920 (trade name, manufactured by Horiba, Ltd.). The measurement result showed that the particle diameter was 0.1043 μm. The pH of the alumina white transparent dispersion liquid was 4.62 when measured at a liquid temperature of 30° C. using a pH meter. The viscosity of the alumina white transparent dispersion liquid was measured in the same manner as follows.

Preparation of Coating Liquid for Ink Receiving Layer

100 parts of the alumina white transparent dispersion liquid obtained above, 34.6 parts of 7% aqueous solution (aqueous binder solution) of PVA-245 (polyvinyl alcohol having a degree of saponification of 88% and an average degree of polymerization of 3500, manufactured by Kuraray Co., Ltd.), 9.7 parts of 7.5% aqueous boric acid solution (aqueous cross linking agent solution), 1.32 parts of 10% aqueous surfactant solution (Emulgen 109P (trade name, manufactured by Kao Corp., HLB 13.6; surfactant)), and 40.5 parts of ion exchange water were warmed to 60° C. before mixing. Then, each liquid after warming was sufficiently mixed while warming at 60° C., thereby preparing a coating liquid for ink receiving layer.

The viscosity measured at 30° C. using a B-type viscometer of the obtained coating liquid of the ink receiving layer was 56 mPa·s. Here, the mass ratio of the alumina hydrate and the PVA (alumina hydrate/PVA) is 10.

Formation of Ink Receiving Layer

Then, the coating liquid for ink receiving layer was cooled to 50° C., and thereafter subjected to ultrasonic degassing treatment for 10 minutes while maintaining the temperature at 50° C. Immediately after the ultrasonic degassing treatment, the coating liquid for ink receiving layer was applied onto the resin layer of the recording medium support produced by the same method as in Example 1 so that the dry solid content of the pseudo boehmite alumina was 40 g/m². After applying, set drying was performed for 2 minutes so that the film surface temperature was 20° C., and then dried at 80° C. for 10 minutes, thereby forming an ink receiving layer on the resin layer of the recording medium support (front surface side). The surface temperature was measured by a radiation thermometer in a state where the moisture was 200 g/m².

The film thickness of the formed ink receiving layer was 40 μm.

Thus, the inkjet recording sheet was produced.

The recording medium support and the produced inkjet recording sheet were subjected to the same measurement and evaluation as in Example 1. The results of the measurement and evaluation are shown in Table 1.

### Example 3

An inkjet recording medium was produced in the same manner as in Example 1, except for changing the film thickness of the resin layer of the inkjet recording sheet (recording medium support) to 14 μm by changing the film thickness of the resin layer on the transfer material.

The recording medium support and the produced inkjet recording medium were subjected to the same measurement and evaluation as in Example 1. The results of the measurement and evaluation are shown in Table 1.

### Example 4

An inkjet recording medium was produced in the same manner as in Example 1, except for changing the film thickness of the resin layer of the inkjet recording sheet (recording medium support) to 3 μm by changing the film thickness of the resin layer on the transfer material.

The recording medium support and the produced inkjet recording medium were subjected to the same measurement and evaluation as in Example 1. The results of the measurement and evaluation are shown in Table 1.

### Comparative Example 1

An inkjet recording medium was produced in the same manner as in Example 1, except for not using the recording medium support in Example 1 and forming the ink receiving layer directly on the front surface of the base paper.

The base paper and the produced inkjet recording medium were subjected to the same measurement and evaluation as in Example 1. The results of the measurement and evaluation are shown in Table 1.

### Comparative Example 2

An inkjet recording medium was produced in the same manner as in Example 1, except for changing the recording medium support in Example 1 to the following recording medium support (WP paper) in which the resin layer was formed by melt extrusion.

The base paper and the produced inkjet recording medium were subjected to the same measurement and evaluation as in Example 1. The results of the measurement and evaluation are shown in Table 1.

Production of Recording Medium Support (WP Paper)

The wire surface (rear surface) side of the base paper produced in the same manner as in Example 1 was subjected to corona discharge treatment, a high density polyethylene and a low density polyethylene were blended at a high density polyethylene/low density polyethylene ratio of 80%/20% using a melt extruder, and then melt extrusion coating of the resultant melt was carried out at a temperature of 320° C. so that the thickness was 7 μm. Thus, a thermoplastic resin layer containing a mat surface was formed (hereinafter the thermoplastic resin layer surface being referred to as a “rear surface”).

The thermoplastic resin layer at the rear surface was further subjected to corona discharge treatment, and thereafter, a dispersion liquid in which an aluminum oxide (“ALUMINA SOL 100” (trade name, manufactured by Nissan Chemical Industries, Ltd.)) as an antistatic agent and a silicon dioxide (“SNOWTEX O” (trade name, manufactured by Nissan Chemical Industries, Ltd.)) were dispersed in water at a mass ratio of 1:2 was applied to the thermoplastic resin layer at the rear surface so that the dry weight was 0.2 g/m².

Subsequently, the front surface was subjected to corona treatment, and then the corona-treated front surface was extrusion coated with polyethylene containing 10 mass % titanium oxide and having a density of 0.93 g/m² at 320° C. using a melt extruder so that the thickness was 7 μm.

Thus, a recording medium support was obtained.

The ink receiving layer was formed on the front surface of the recording medium support.

### Comparative Example 3

An inkjet recording medium was produced in the same manner as in Example 1, except for changing the film thickness of the resin layer of the inkjet recording sheet (recording medium support) to 25 μm by changing the film thickness of the resin layer on the transfer material.

The recording medium support and the produced inkjet recording medium were subjected to the same measurement and evaluation as in Example 1. The results of the measurement and evaluation are shown in Table 1.

### Comparative Example 4

An inkjet recording medium was produced in the same manner as in Example 1, except for changing the recording medium support in Example 1 to the following recording medium support in which the resin layer was formed by coating and soft calender treatment.

The base paper and the produced inkjet recording medium were subjected to the same measurement and evaluation as in Example 1. The results of the measurement and evaluation are shown in Table 1.

Production of Recording Medium Support

The front surface of the base paper produced in the same manner as in Example 1 was subjected to corona treatment, and the binder used in the coating liquid for resin layer of Example 1 was applied by extrusion die coater to the corona-treated front surface so that the thickness was 7 μm, thereby forming a resin layer.

Furthermore, the resin layer was formed on the rear surface (wire surface) of the base paper in the same manner as above.

Thereafter, the formed resin layer was subjected to soft calender treatment described below.

### Soft Calender Treatment

The base paper on which the resin layer was formed was subjected to soft calender treatment using a soft calender provided with a pair of rollers in which a metal roll and a resin roll make a pair under the conditions of a surface temperature of the metal roll of 50° C. and a nip pressure of 50 kg/cm. In this case, the treatment was performed so that the front surface side was on the metal roll side.

Thus, a recording medium support was obtained.

The ink receiving layer was formed on the front surface of the recording medium support.

TABLE 1

| | Ex. 1 | Ex. 2 | Ex. 3 | Ex. 4 | Comp. Ex. 1 | Comp. Ex. 2 | Comp. Ex. 3 | Comp. Ex. 4 |
|---|---|---|---|---|---|---|---|---|
| Surface | 0.04 | 0.04 | 0.03 | 0.06 | 0.18 | 0.10 | 0.02 | 0.15 |
| roughness | | | | | | | | |
| SRa of ink | | | | | | | | |
| receiving | | | | | | | | |
| layer (μm) | | | | | | | | |
| Pigment in | Silica | Pseudo | Silica | Silica | Silica | Silica | Silica | Silica |
| ink | | boehmite | | | | | | |
| receiving | | | | | | | | |
| layer | | | | | | | | |
| Surface | 0.04 | 0.04 | 0.03 | 0.06 | 0.20 | 0.10 | 0.02 | 0.15 |
| roughness | | | | | | | | |
| SRa of resin | | | | | | | | |
| layer (μm) | | | | | | | | |
| Film | 7 μm | 7 μm | 14 μm | 3 μm | No resin layer | 7 μm | 25 μm | 7 μm |
| thickness of | | | | | | | | |
| resin layer | | | | | | | | |
| Method for | Transfer | Transfer | Transfer | Transfer | No resin layer | Melt extrusion | Transfer | Coating and |
| forming | | | | | | | | calender |
| resin layer | | | | | | | | |
| Image | A | A | A | B | D | C | A | C |
| clarity | | | | | | | | |
| Glossiness | A | A | A | A | C | B | A | B |
| Brittleness | A | A | B | A | A | A | C | A |

As shown in Table 1, the inkjet recording media of Examples 1 to 4 having the resin layer having a thickness of from 2 μm to 20 μm and the ink receiving layer containing a pigment and a water-soluble resin in this order, in which the surface roughness SRa of each of the resin layer and the ink receiving layer was 0.08 μm or less, had excellent image clarity and glossiness and reduced brittleness.

All publications, patent applications, and technical standards mentioned in this specification are herein incorporated by reference to the same extent as if each individual publication, patent applications, or technical standards was specifically and individually indicated to be incorporated by reference.

What is claimed is:

1. An inkjet recording medium comprising a paper support, and a resin layer having a thickness of from 2 μm to 20 μm and an ink receiving layer containing a pigment and a water-soluble resin provided in this order on the paper support, wherein a center surface average roughness (SRa value) of a surface of the ink receiving layer provided on the paper support is 0.08 μm or less, provided that the SRa value is measured at a cutoff value of from 0.2 mm to 0.3 mm.

2. The inkjet recording medium according to claim 1, wherein the resin layer is formed by transferring the resin layer from a transfer material comprising the resin layer on a temporary support, onto the paper support.

3. A method for producing an inkjet recording medium, the method comprising:
forming a resin layer having a thickness of from 2 μm to 20 μm on a paper support by transferring the resin layer from a transfer material comprising the resin layer on a temporary support, and
forming an ink receiving layer containing a pigment and a water-soluble resin on the resin layer formed on the paper support.

4. The method for producing an inkjet recording medium according to claim 3, wherein the transferring of the resin layer is carried out by heat pressure bonding.

5. The method for producing an inkjet recording medium according to claim 3, further comprising:
prior to the forming of the resin layer on the paper support, producing the transfer material by applying a resin composition onto the temporary support and drying the resin composition to form the resin layer on the temporary support.

6. The method for producing an inkjet recording medium according to claim 3, wherein the temporary support is a resin film.

7. The method for producing an inkjet recording medium according to claim 3, wherein a center surface average roughness (SRa value) of a surface of the ink receiving layer provided on the paper support is 0.08 μm or less, provided that the SRa value is measured at a cutoff value of from 0.2 mm to 0.3 mm.

8. A recording medium support comprising a resin layer having a thickness of from 2 μm to 20 μm on a paper support, in which a center surface average roughness (SRa value) of a surface of the resin layer provided on the paper support is 0.08 μm or less, provided that the SRa value is measured at a cutoff value of from 0.2 mm to 0.3 mm.

9. The recording medium support according to claim 8, wherein the resin layer is formed by transferring the resin layer from a transfer material comprising the resin layer on a temporary support, onto the paper support.

10. A method for producing a recording medium support, the method comprising:
forming a resin layer having a thickness of from 2 μm to 20 μm on a paper support by transferring the resin layer from a transfer material comprising the resin layer on a temporary support.
